(19) United States
(12) Patent Application Publication
(10) Pub. No.: US 2015/0313799 A1
(43) Pub. Date: Nov. 5, 2015

(54) REMINDER CAP

(71) Applicant: Anies ALFAYYAD, Indianapolis, IN (US)

(72) Inventor: Anies Alfayyad, Indianapolis, IN (US)

(21) Appl. No.: 14/654,080

(22) PCT Filed: Dec. 19, 2013
(86) PCT No.: PCT/US2013/076604

§ 371 Date: Jun. 19, 2015

Related U.S. Application Data
(60) Provisional application No. 61/740,827, filed on Dec. 21, 2012.

(51) Int. Cl. A61J 7/04; A61J 1/14; B65D 51/24

(52) U.S. Cl. CPC A61J 7/04; B65D 51/245; A61J 1/1412

(57) ABSTRACT

This disclosure relates to caps for containers, bottles and the like, and more particularly, to caps having reminder means to assist the user in remembering the next time a given activity is to be performed, such as the next time a dosage of medication should be taken.

### CROSS REFERENCE TO RELATED APPLICATION

This application claims the benefit of priority to U.S. Provisional Patent Application Ser. No. 61/740,827, filed Dec. 21, 2012, entitled REMINDER CAP, incorporated herein by reference.

### TECHNICAL FIELD

This disclosure relates to caps for containers, bottles and the like, and more particularly, to caps having reminder means to assist the user in remembering the next time a given activity is to be performed.

### BACKGROUND

In the medical field, medical drugs have a predetermined therapeutic range in which the effects of taking the drug are beneficial. Under-utilization of a drug may endanger the user with the drug's side effects without reaching levels necessary for a therapeutic action. On the other hand, over-utilization may cause side effects or toxicity to a much greater extent than any possible benefit. Thus, it is critical that a patient follow prescribed directions on medications; yet, patients frequently forget whether or when they have taken medication. Patients also frequently forget when they are supposed to take the next dose of medication. These issues typically cause patients to either omit doses or repeat them.

A considerable number of pill-timing schemes have been used to solve the problem of reminding a patient to take a dose of medicine or reminding him he has already taken the dose. Conventional ones involve some scheme of compartmentalization of the necessary medication, such that the pills are placed in compartments that are labeled by day, dose number or time of day, or that are serially numbered. These devices are reasonably satisfactory if a responsible person is available and has the time and patience to fill the compartments properly.

### SUMMARY

In dispensing pills of a single type, a window-containing pharmaceutical bottle cap is disclosed. Reminder indicia symbols are visible through the window to remind the viewer of the next time a given activity is to be performed.

The present disclosure includes a reminder cap comprising a reminder wheel including at least one indicia symbol, wherein the at least one indicia symbol correlates to a sequence of a medication dose; and an outer cover engaging the reminder wheel, the outer cover rotatable relative to the reminder wheel, the outer cover including a window; wherein the reminder wheel includes one of at least one jut and at least one recess, located co-radially to the at least one indicia symbol; wherein the outer cover includes the other of at least one jut and at least one recess, located co-radially to the window; wherein the at least one jut is configured to engage the at least one recess as a detent mechanism; and wherein the window is configured to frame the indicia symbol when the jut engages the recess.

The present disclosure further includes a method for providing a reminder comprising providing a bottle having a cap, the bottle for containing a dose of medication; attaching to the cap a reminder wheel, the reminder wheel rotatably engaged by an outer cover including a window; and rotating the outer cover until the window frames an indicia symbol on the reminder wheel corresponding to a next time to take the dose of medication.

The present disclosure also includes a method for providing a reminder comprising providing a bottle, the bottle for containing a dose of medication; providing a cap for the bottle, the cap including an integral reminder wheel, the reminder wheel rotatably engaged by an outer cover including a window; and rotating the outer cover until the window frames an indicia symbol on the reminder wheel corresponding to a next time to take the dose of medication.

It is an object of the present disclosure to provide a reminder device to remind the user the next time a given activity is to be performed. The present invention may have applicability in the control of chemical containers, such as pharmaceutical bottles, as well as many other areas.

More particularly, it is an object of the present disclosure to provide an reminder cap for a medication dispensing bottle or the like that provides a reminder for the user as to the next time another dose of medication should be taken.

Yet another object of the disclosure is to provide a color coded indicia means to indicate the time of day that a given activity is to be performed.

Still another object is to provide a detent within a device as the locking mechanism in order to provide indicia means visible through a window.

Still yet another object is to provide a detent within a device as the locking mechanism to allow portions of the device to slide past each other when not engaged to allow such mechanisms to work reliably over a long period of time. The detent also prevents backward movement of the reminder wheel.

Another object of the present disclosure is to combine functions usually requiring several components into a single component to reduce the complexity of the device and provide ease of manufacturability and assembly.

Another object of the present disclosure is to provide a reminder assembly that can easily be mounted or attached to an ordinary cap without requiring any special modifications to the cap itself or to the bottle.

Another object is to provide a device that can be easily grasped by elderly or impaired patients, as by including grasp-facilitating elements on the device.

Another object is to provide a device which is easily manufactured and assembled and that includes interchangeable parts among devices for different dosage schedules.

These and other objects of the present disclosure are provided by a reminder cap having an outer cover with a window present in the outer cover. Beneath the window is a reminder wheel having numbers, days, times, colors or other indicia serving as reminder symbols engraved or printed thereon that are visible through the window to indicate the next time the indicated event is to occur. The outer cover also includes a detent portion on the underside of the outer cover, such as a jut. The reminder wheel includes another detent portion that is set to engage the jut such that the window of the outer cover is aligned with indicia on the reminder wheel. This engagement causes the indicia carried by the reminder wheel to be displayed through the window to a user.

To provide for ease of assembly during the manufacturing process, the outer cover and reminder wheel are provided to easily engage pharmaceutical bottle caps. The outer cover includes side walls configured to engage and/or frictionally snap into a groove on a pharmaceutical bottle cap to firmly hold the device together and prevent disassembly.

The reminder wheel is configured to fit between the outer cover and the pharmaceutical bottle cap. The reminder wheel is sized and shaped to remain within the assembly as it operates and remain on the same rotational axis as the outer cover and the pharmaceutical bottle cap.

The reminder wheel or cap is particularly, but not exclusively, useful to indicate dosage schedules on a medicine container. The reminder wheel or cap may be attached to a standard medicine container cap or other cap. The reminder indicia appearing on the reminder wheel may be raised or recessed relative to the top surface of the reminder wheel and may even be in braille, and the window in the outer cover may be rounded, so that the patient can feel the reminder symbols with a thumb or finger.

In one embodiment, multiple reminder wheels are utilized to indicate different dose schedules. In another embodiment, the number and configuration of tabs on the reminder wheel are optimized such that a single reminder wheel can be used for a variety of dose schedules in order to maximize assembly flexibility and minimize manufacturing costs. The number and configuration of the reminder wheel may also be optimized such that the reminder wheel can be inserted between the outer cover and the pharmaceutical bottle cop without misaligning the window and the reminder indicia.

Certain embodiments of the disclosure include the outer cover including an arrow for instructing the user or attaching the outer cover onto the standard pharmaceutical bottle cap in a desired orientation with respect to the arrow. Other embodiments include grasping portions on the periphery of the device to facilitate the turning of the outer cover.

It will be appreciated that the various apparatus described in this summary section, as well as elsewhere in this application, can be expressed as a large number of different combinations and subcombinations. All such useful, novel, and inventive combinations and subcombinations are contemplated herein, it being recognized that the explicit expression of each of these combinations is excessive and unnecessary.

### BRIEF DESCRIPTION OF THE DRAWINGS

The aforementioned and other features of this disclosure, and the manner of attaining them, will become more apparent and the disclosure itself will be better understood by reference to the following description of embodiments of the disclosure taken in conjunction with the accompanying drawings, wherein:

FIG. 1A is a top view of a reminder wheel disposed on a pharmaceutical bottle cap according to an embodiment of the present disclosure wherein the reminder wheel features a one-a-day dose schedule;

FIG. 1B is a side view of the reminder wheel disposed on a pharmaceutical bottle cap from FIG. 1A;

FIG. 1C is a top view of an outer cover according to an embodiment of the present disclosure with the outer cover featuring an observation port or window;

FIG. 1D is a side view of the outer cover from FIG. 1C;

FIG. 2A is a top view of a reminder wheel disposed on a pharmaceutical bottle cap according to another embodiment of the present disclosure wherein the reminder wheel features a two-a-day dose schedule;

FIG. 2B is a side view of the reminder wheel disposed on a pharmaceutical bottle cap from FIG. 2A;

FIG. 3A is a top view of a reminder wheel disposed on a pharmaceutical bottle cap according to yet another embodiment of the present disclosure wherein the reminder wheel features a three-a-day dose schedule;

FIG. 3B is a side view of the reminder wheel disposed on a pharmaceutical bottle cap from FIG. 3A;

FIG. 4A is a top view of a reminder wheel disposed on a pharmaceutical bottle cap according to still yet another embodiment of the present disclosure, the reminder wheel featuring a four-a-day dose schedule;

FIG. 4B is a side view of the reminder wheel disposed on a pharmaceutical bottle cap from FIG. 4A;

FIG. 5A is a top view of a reminder wheel disposed on a pharmaceutical bottle cap according to even yet another embodiment of the present disclosure, the reminder wheel featuring a 24-hour dose schedule;

FIG. 5B is a side view of the reminder wheel disposed on a pharmaceutical bottle cap from FIG. 5A;

FIG. 5C is a perspective view of a reminder cap according to even yet another embodiment of the present disclosure, the device comprising the outer cover of FIGS. 1C and 1D and the reminder wheel of FIGS. 5A and 5B disposed on a pharmaceutical bottle cap, the reminder cap illustrating a 24-hour dose schedule;

FIG. 6A is a top view of a reminder wheel disposed on a pharmaceutical bottle cap according to still even yet another embodiment of the present disclosure, the reminder wheel featuring a four-dose schedule;

FIG. 6B is a side view of the reminder wheel disposed on a pharmaceutical bottle cap from FIG. 6A;

FIG. 6C is a top view of an outer cover according to an embodiment of the present disclosure, the outer cover featuring a four-sided observation port or window;

FIG. 6D is a side view of the outer cover from FIG. 6C;

FIG. 6E is a perspective view of a reminder cap according to still even yet another embodiment of the present disclosure, the reminder cap comprising the outer cover of FIGS. 6C and 6D and the reminder wheel of FIGS. 6A and 6B disposed on a pharmaceutical bottle cap, the reminder cap illustrating a four-dose schedule;

FIG. 7A is a top view of a reminder wheel disposed on a pharmaceutical bottle cap according to the embodiment of the present disclosure shown in FIG. 1A;

FIG. 7B is a top view of an outer cover according to the embodiment of the present disclosure shown in FIG. 1C, the outer cover featuring an observation port or window;

FIG. 7C is a side view of the reminder wheel of FIG. 7A;

FIG. 7D is a side view of the outer cover of FIG. 7B;

FIG. 8A is a top view of a reminder wheel disposed on a pharmaceutical bottle cap according to the embodiment of the present disclosure shown in FIG. 2A;

FIG. 8B is a top view of an outer cover according to the embodiment of the present disclosure shown in FIG. 1C, the outer cover featuring an observation port or window;

FIG. 8C is a side view of the reminder wheel of FIG. 8A;

FIG. 8D is a side view of the outer cover of FIG. 8B;

FIG. 9A is a top view of a reminder wheel disposed on a pharmaceutical bottle cap according to the embodiment of the present disclosure shown in FIG. 3A;

FIG. 9B is a top view of an outer cover according to the embodiment of the present disclosure shown in FIG. 1C, the outer cover featuring an observation port or window;

FIG. 9C is a side view of the reminder wheel of FIG. 9A;

FIG. 9D is a side view of the outer cover of FIG. 9B;

FIG. 10A is a top view of a reminder wheel disposed on a pharmaceutical bottle cap according to the embodiment of the present disclosure shown in FIG. 4A;

FIG. 10B is a top view of an outer cover according to the embodiment of the present disclosure shown in FIG. 1C, the outer cover featuring an observation port or window;

FIG. 10C is a side view of the reminder wheel of FIG. 10A;

FIG. 10D is a side view of the outer cover of FIG. 10B;

FIG. 11A is a top view of a reminder wheel disposed on a pharmaceutical bottle cap according the embodiment of the present disclosure shown in FIG. 5A;

FIG. 11B is a top view of an outer cover according the embodiment of the present disclosure shown in FIG. 1C, the outer cover featuring an observation port or window;

FIG. 11C is a side view of the reminder wheel of FIG. 11A;

FIG. 11D is a side view of the outer cover of FIG. 11B;

FIG. 12A is a top view of a reminder wheel disposed on a pharmaceutical bottle cap according to the embodiment of the present disclosure shown in FIG. 6A;

FIG. 12B is a top view of an outer cover according to the embodiment of the present disclosure shown in FIG. 6C;

FIG. 12C is a side view of the reminder wheel of FIG. 12A; and

FIG. 12D is a side view of the outer cover of FIG. 12B.

Corresponding reference characters indicate corresponding parts throughout the several views. Although the drawings represent embodiments of the present disclosure, the drawings are not necessarily to scale and certain features may be exaggerated in order to better illustrate and explain the present disclosure.

### DESCRIPTION OF THE ILLUSTRATED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

At least one embodiment of the present invention will be described and shown, and this application may show and/or describe other embodiments of the present invention. It is understood that any reference to “the invention” is a reference to an embodiment of a family of inventions, with no single embodiment including an apparatus, process, or composition that must be included in all embodiments, unless otherwise stated.

The present disclosure describes a reminder device for assisting the user in remembering the next time a given activity is to be performed. The present disclosure also provides a reminder cap intended for a medication dispensing bottle or the like that provides a reminder the next time the bottle is to be opened and the next dose taken.

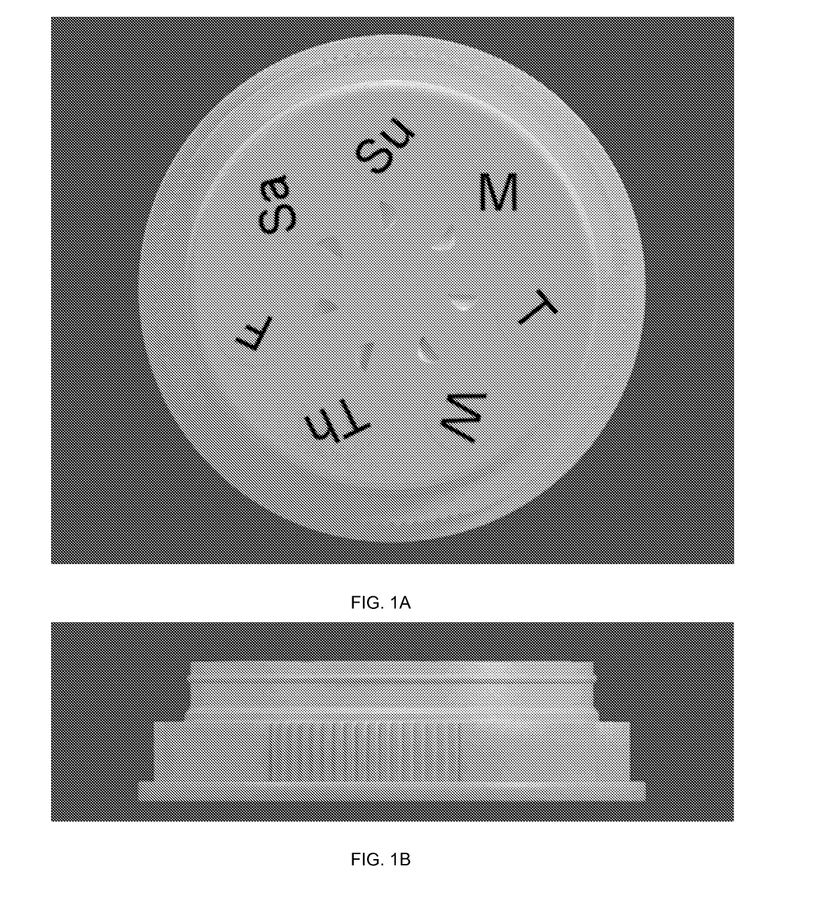

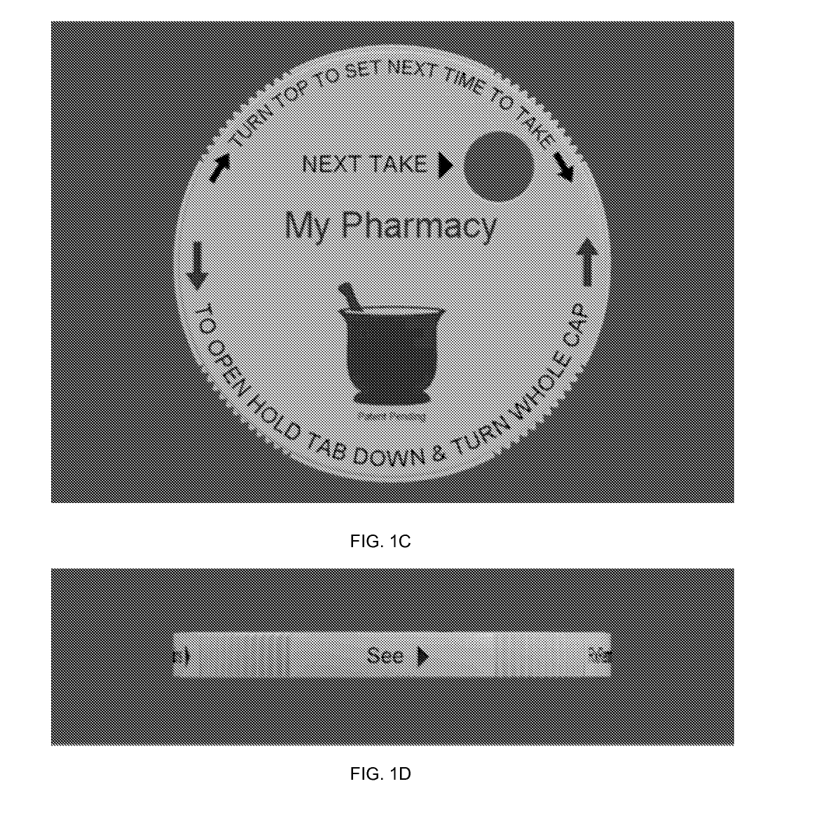

FIGS. 1A and 1B illustrate a reminder wheel according to one embodiment of the present disclosure. The reminder wheel is preferably located on a pharmaceutical bottle cap and includes indicia symbols reflecting a sequence of medication doses. The device also defines either a single recess or a series of recesss wherein each recess corresponds to a single indicia symbol of the sequence of doses. The recesses are part of a detent mechanism described in greater detail below. In the depicted embodiment, the reminder wheel includes seven radially spaced recesses and seven indica symbols located co-radially to the recesses. In this embodiment, each indicia symbol indicates a day of the week.

The reminder wheel can be made of plastic as well as other materials. It is envisioned the reminder wheel can either be a separate component from the pharmaceutical bottle cap or an integral part of the cap. In either embodiment it is envisioned that several different embodiments of the reminder wheel of this invention can be utilized to provide for different sequences of doses.

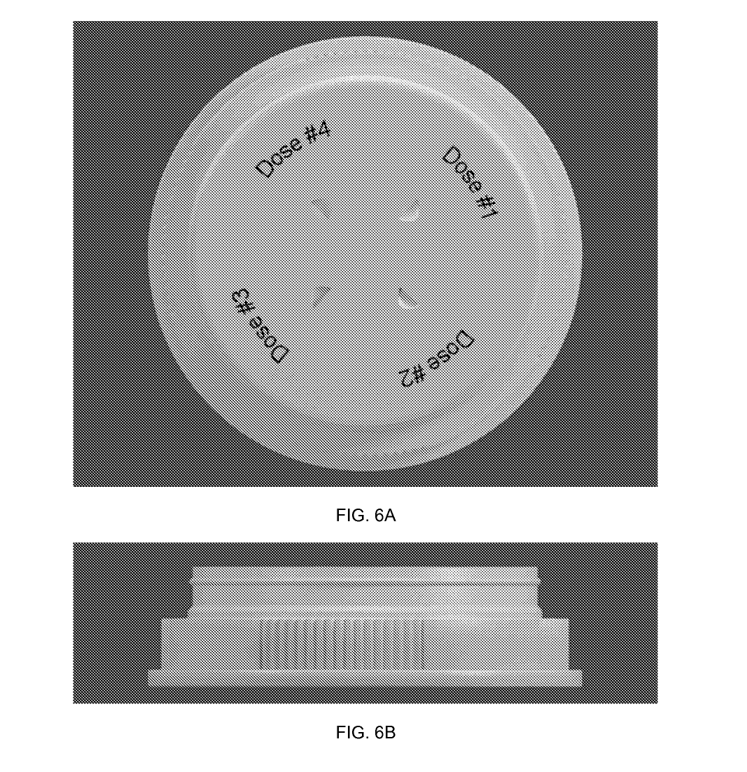

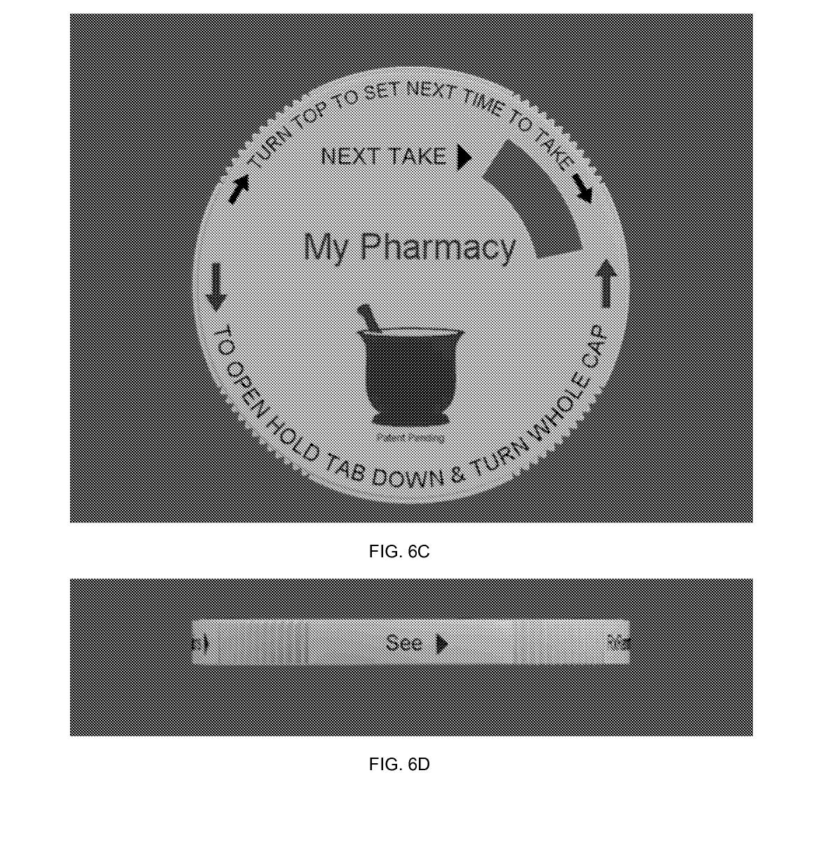

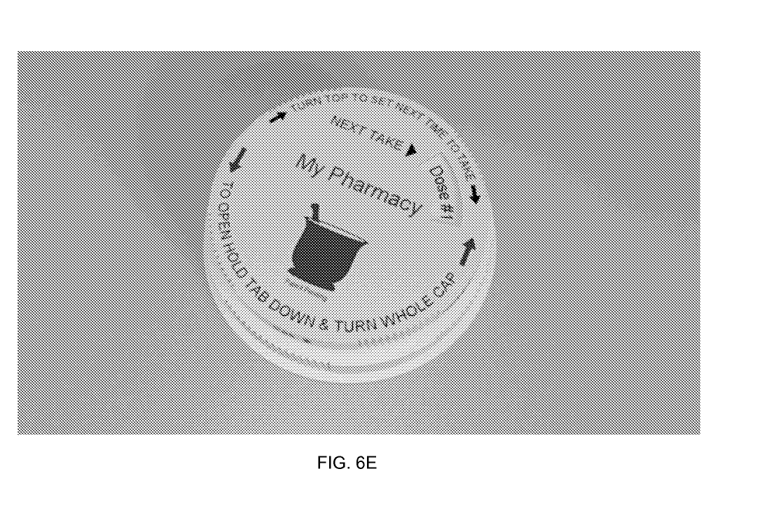

The complete device may also be comprised of multiple parts such as a reminder wheel (FIGS. 1A, 1B, 2A, 2B, 3A, 3B, 4A, 4B, 5A, 5B, 6A, and 6B), a bottle cap and an outer cover (FIGS. 1C, 1D, 6C, and 6D). The outer cover is configured to fasten to the bottle cap. The outer cover is fastened to bottle cap by any suitable means and, as best illustrated in FIGS. 1C and 6C, includes a port or window to permit the viewing of the reminder indicia symbols carried by the reminder wheel. The outer cover partially covers the reminder window and blocks viewing of the indicia symbols, apart from any indicia symbol visible through the window.

The outer cover may also include a jut as part of a detent mechanism. The jut is configured to correspond and interact with recesses disposed on the reminder wheel, thereby collectively creating a detent mechanism. The jut is located preferably on the bottom side of the outer cover co-radially with the window. As a detent mechanism, the outer cover is configured to removably lock into variable positions corresponding to one of the indicia symbols being visible through the window. The detent mechanism is configured to allow rotation of the outer cover relative to the reminder wheel to allow for changes in the reminder indicia visible through the window. The detent mechanism is configured to work reliably for a long period of time.

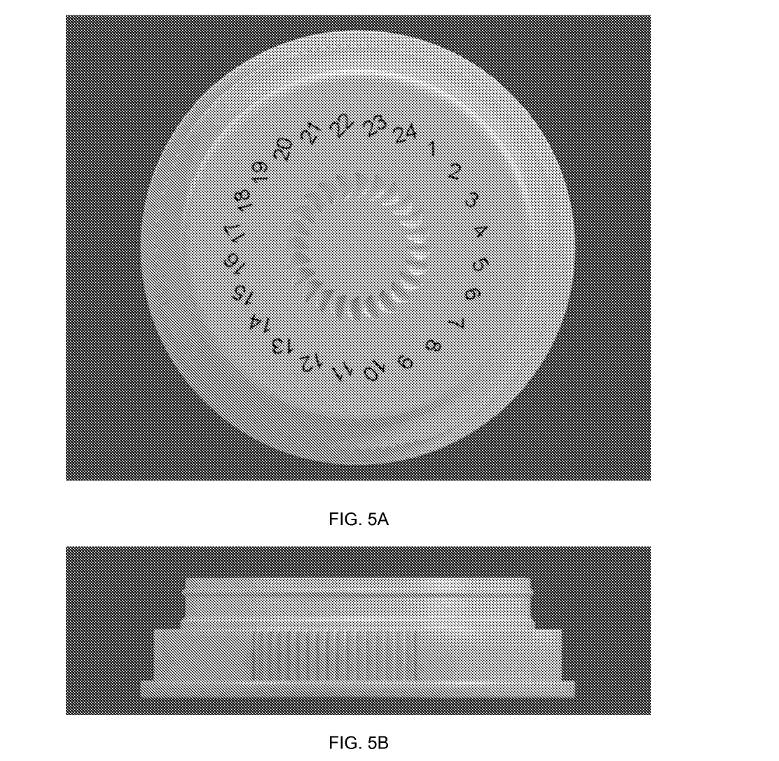

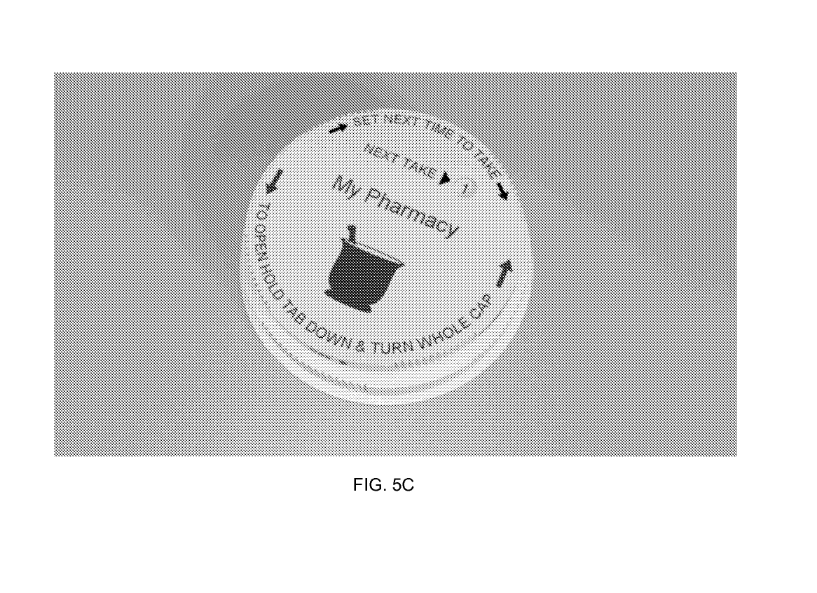

FIGS. 5C and 6E illustrate complete and assembled reminder caps according to embodiments of the present disclosure.

Referring now to FIGS. 7A-7D, these and other objects of the present disclosure are provided by a reminder cap having an outer cover 110 equipped with a port or window 112 in the outer cover 110. Beneath the window 112, and within the body of the device, is a reminder wheel 130 having numbers, days, times, colors or other reminder indicia symbols engraved or printed thereon or attached thereto that are visible through the window to remind the user the next time the indicated event is to occur. In one example, the indicated event is the time for a patient to take a dosage of medication from a bottle associated with the reminder cap. The outer cover 110 preferably includes a detent portion on the underside of the outer cover 110, such as at least one jut 114, as depicted in dashed lines in FIGS. 7B and 7D. The reminder wheel preferably includes another detent portion, such as at least one recess 132, that is set to engage the detent portion of the outer cover (for example, the jut 114) when the window 112 of the outer cover 110 is aligned with an indicia symbol on the reminder wheel 130. This engagement causes the indicia symbol of the reminder wheel to be displayed through the window 112 to a user when the detent portions interact with one another, providing a type of ratcheting mechanism for aligning the outer cover 110 and the reminder wheel 130. In alternate embodiments, the at least one recess 132 may be located on the outer cover 110 and the at least one jut 114 may be located on the reminder wheel.

In the illustrated embodiments, the reminder wheel is an integral part of the bottle cap, with the indicia symbols printed on the top surface of the cap and the at least one recess formed in the top surface of the cap. In other embodiments, the reminder wheel is a generally circular frame attachable to a pharmaceutical bottle cap or other cap. FIG. 7C illustrates, using braces, the portions of the structure that would constitute the reminder wheel 133 and the cap 134, should the reminder wheel and cap be separate pieces.

To provide for ease of assembly during the manufacturing process, the outer cover and reminder wheel are configured to readily engage each other. In the embodiment illustrated in FIGS. 7A-7D, the outer cover 110 includes a side wall 116, the inner surface of which is configured to engage and/or frictionally snap into a groove 136 provided on the reminder wheel to secure the outer cover 110 to the reminder wheel 130 and prevent inadvertent disassembly. In other embodiments (not shown), the side wall of the outer cover includes a groove and the outer peripherial edge of the reminder wheel is configured to engage and/or frictionally snap into the groove. In yet other embodiments, other means known in the art for rotatably securing parts are used for engagement of the outer cover and reminder wheel.

The outer cover can also include knurls or teeth 118 disposed about the peripheral edge of the side wall 116 of the outer cover 110 to aid the user in grasping and rotating the outer cover relative to the reminder wheel.

The outer cover preferably rotates only in the clockwise direction, opposite the counter-clockwise rotation typically used to remove caps from bottles. In some embodiments, the outer cover is restrained from rotating in a counter-clockwise direction by the shape of the jut 114, the shape of the recess 132, or both. In the illustrated embodiment, both the jut 114 and recess 132 are shaped to engage each other with curved surfaces if rotated clockwise and with flat surfaces if rotated counter-clockwise. Contact between the flat surfaces restrains counter-clockwise rotation of the outer cover. Less force is required to rotate the outer cover in a clockwise direction, as the curved surface of the jut 114 passes over the curved surface of the recess 132

The outer cover is configured to fit on top of the reminder wheel and the pharmaceutical bottle cap. The reminder wheel is sized and shaped to remain within the assembly as it operates and remain on the same rotational axis as the outer cover and the pharmaceutical bottle cap. (Note that even though the reminder wheel and the cap are on the same axis, the outer cover and the cap may rotate in opposite directions.)

The reminder cap is particularly, but not exclusively, useful to indicate dosage schedules on a medicine container, such as a medicine bottle. The reminder device may be attached to a standard medicine container cap or other cap. The reminder symbols on the reminder wheel may be raised or recessed relative to the reminder wheel top surface, and may also be in braille. The port or window present in the outer cover may be rounded, so that the patient can feel the reminder symbols with a thumb or finger. The reminder device can also be made to fit a bottle for containing liquid.

In one embodiment, multiple reminder wheels are utilized to remind the user of different dose schedules. In another embodiment, the number and configuration of tabs on the reminder wheel are optimized such that a single reminder wheel can be used for a variety of dose schedules in order to maximize assembly flexibility and minimize manufacturing costs. The number and configuration of the reminder wheel may also be optimized such that the reminder wheel can be inserted between the outer cover and the pharmaceutical bottle cap without misaligning the window and the reminder symbols.

Certain embodiments of the disclosure include the outer cover including an arrow for instructing the user or attaching the outer cover onto the standard pharmaceutical bottle cap in a desired orientation with respect to the arrow. Other embodiments include grasping portions, such as teeth or knurls, provided on the outer peripherial edge of the outer cover to facilitate the turning of the outer cover.

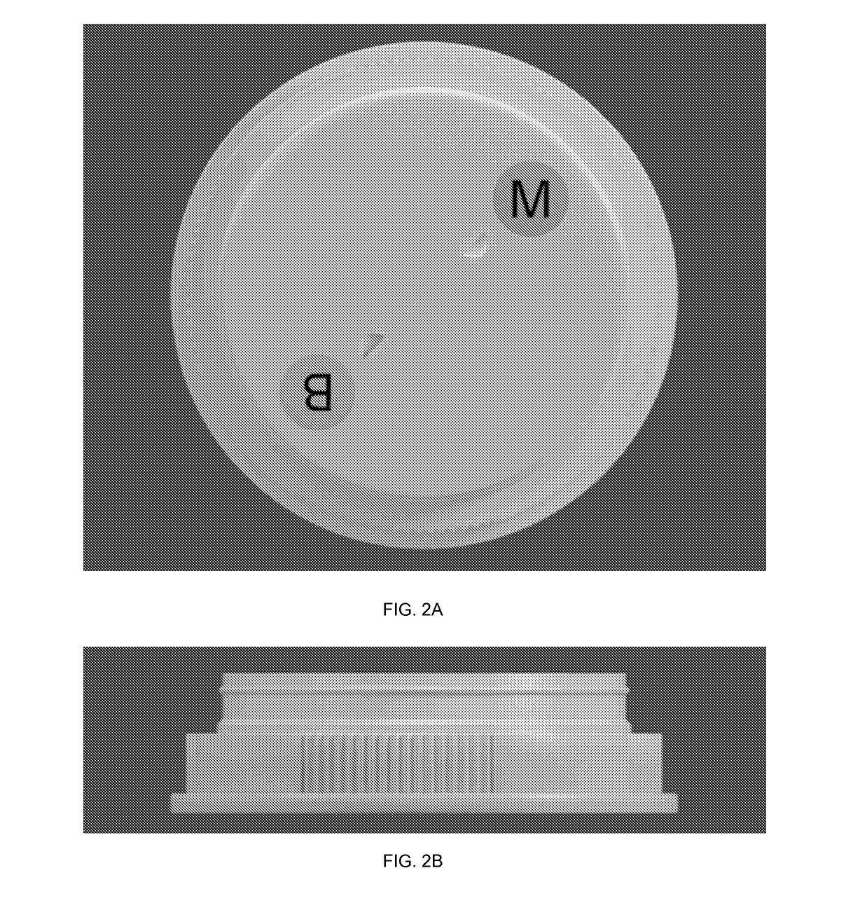

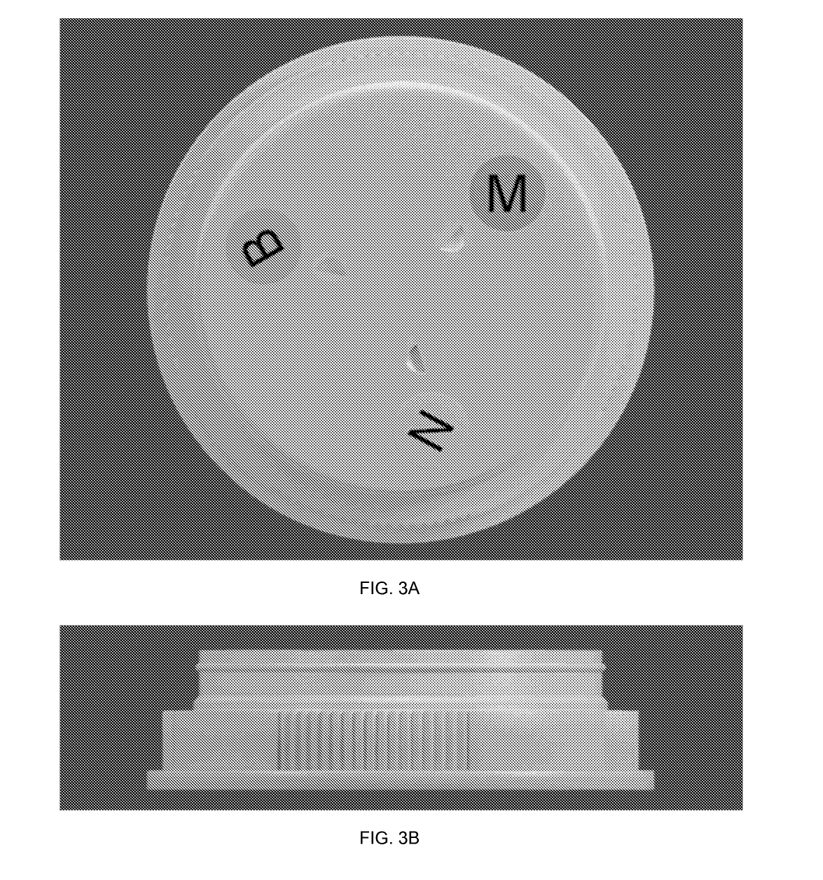

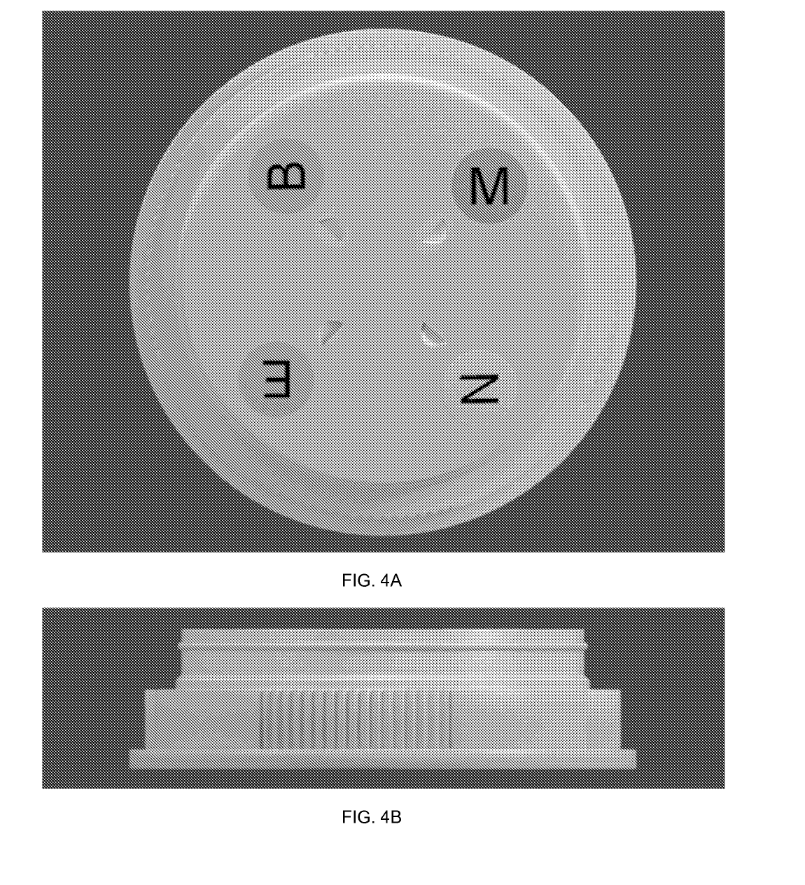

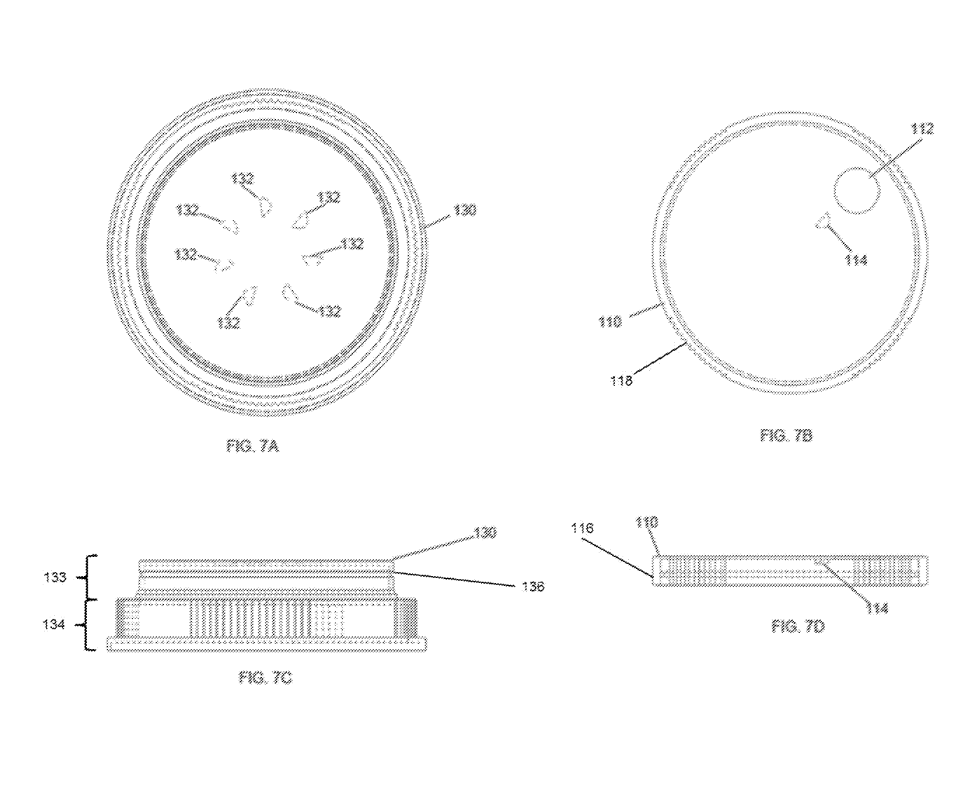

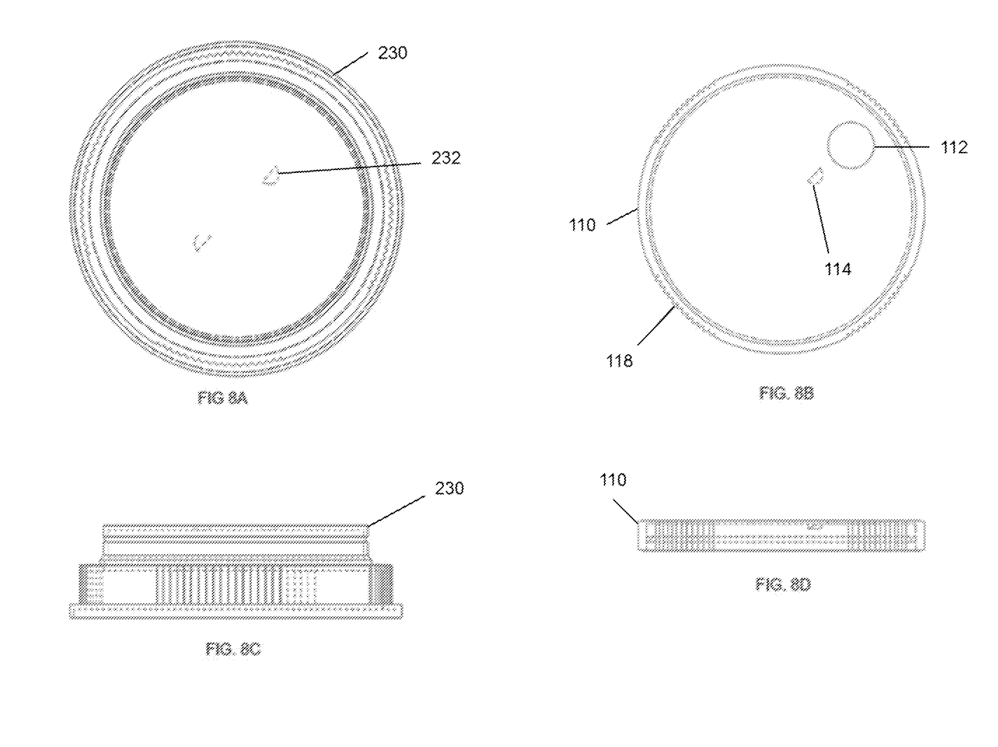

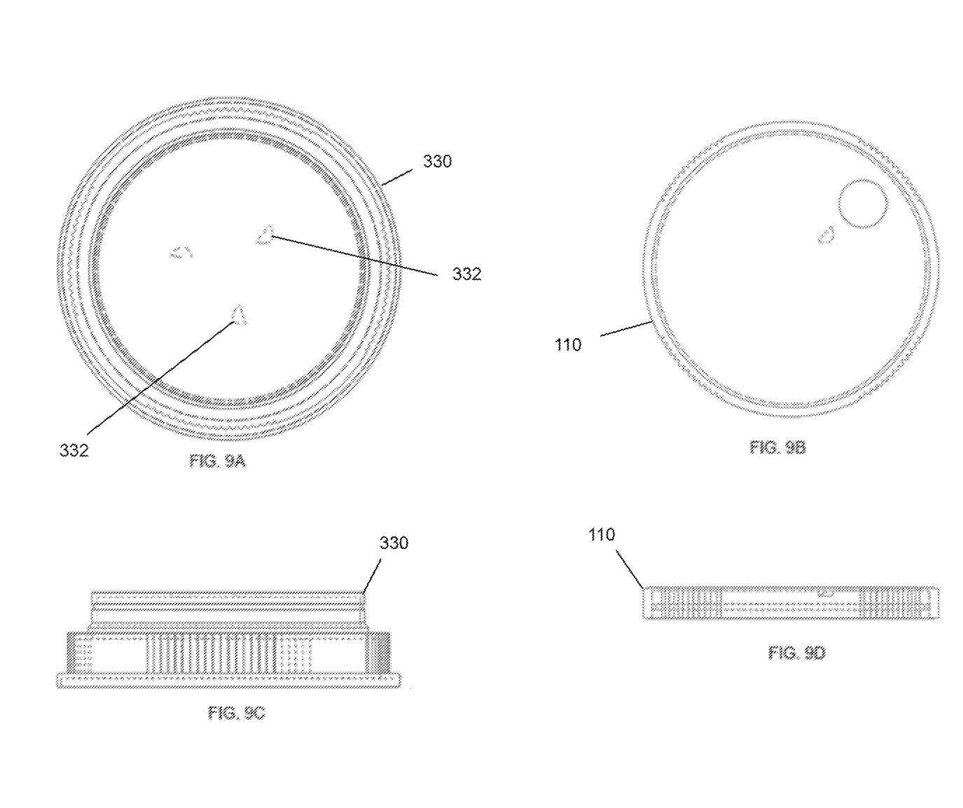

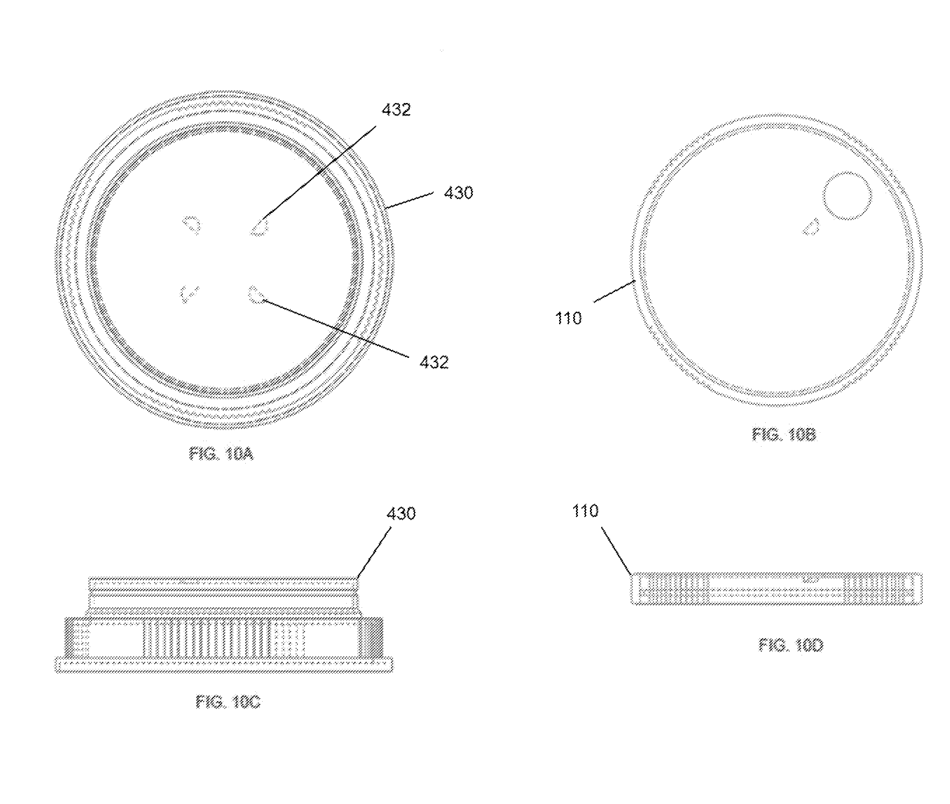

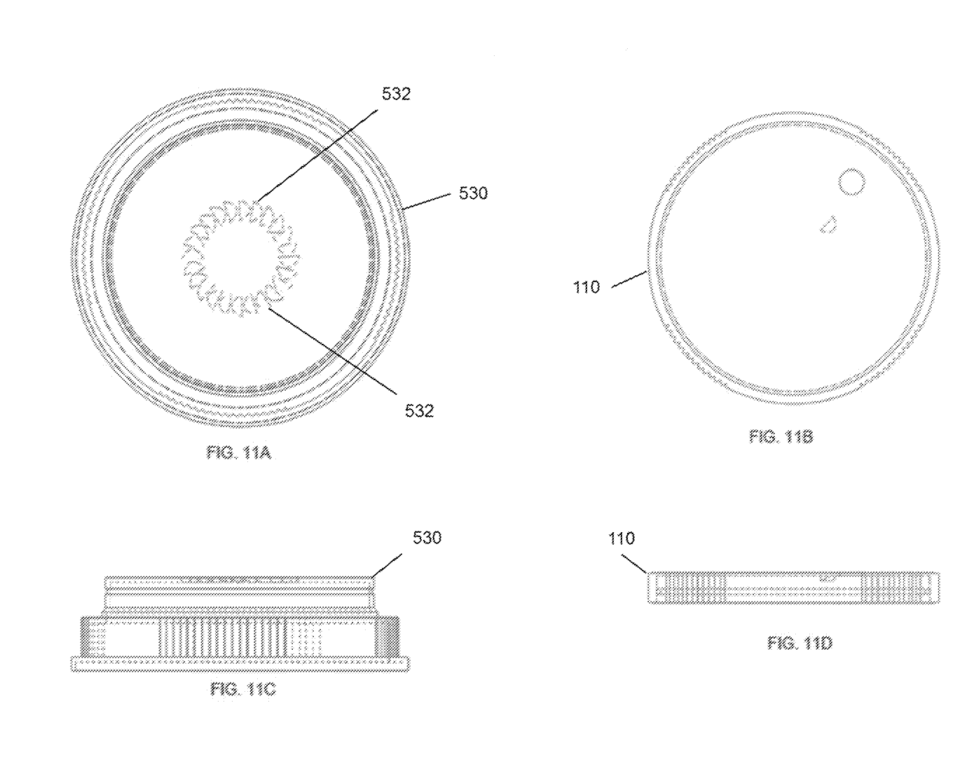

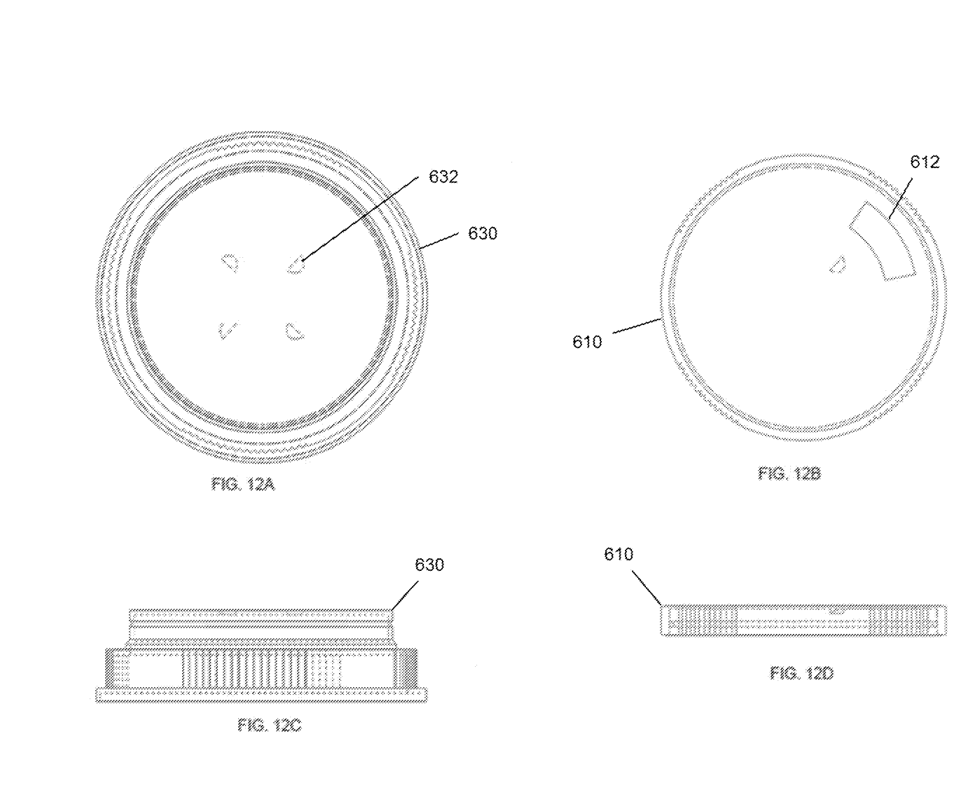

FIGS. 1A, 1B, 2A, 2B, 3A, 3B, 4A, 4B, 5A, 5B, 6A, 6B, 7A, 7C, 8A, 8C, 9A, 9C, 10A, 10C, 11A, 11C, 12A, and 12C illustrate different embodiments of reminder wheel according to multiple embodiments of the present disclosure. The illustrated embodiments differ in the number of recesses and indicia symbols located co-radially to the recesses. For example, the embodiment illustrated in FIGS. 1A, 1B, 7A, and 7C includes seven recesses 132, each associated with an indicia symbol (shown only in FIG. 1A) representing a day of the week. The embodiment of the reminder wheel 230 illustrated in FIGS. 2A, 2B, 8A, and 8C includes two recesses 232, each associated with an indicia symbol (shown only in FIG. 2A) representing the time of day (“M” for morning and “B” for bedtime). The embodiment of the reminder wheel 330 illustrated in FIGS. 3A, 3B, 9A, and 9B includes three recesses 332, each associated with an indicia symbol (shown only in FIG. 3A) representing the time of day (“M” for morning, “N” for noon, and “B” for bedtime). The embodiment of the reminder wheel 430 illustrated in FIGS. 4A, 4B, 10A, and 10C includes four recesses 432, each associated with an indicia symbol (shown only in FIG. 4A) representing the time of day (“M” for morning, “N” for noon, “E” for evening, and “B” for bedtime). The embodiment of the reminder wheel 530 illustrated in FIGS. 5A, 5B, 11A, and 11C includes twenty-four recesses 532, each associated with an indicia symbol (shown only in FIG. 5A) representing the hour of the day. The embodiment of the reminder wheel 630 illustrated in FIGS. 6A, 6B, 12A, and 12C Includes four recesses 632, each associated with an indicia symbol (shown only in FIG. 6A) representing the dose to be taken. In addition to the indicia of a sequence of doses, each indicia symbol may also be color coded to indicate the time of day that a given activity is to be performed or other relevant information.

FIGS. 1C, 1D, 7B, 7D, 8B, 8D, 9B, 9D, 10B, 10D, 11B, and 11D illustrate an embodiment of the outer cover 110 according to an embodiment of the present disclosure wherein the outer cover includes a circular observation port of window 112. FIGS. 6C, 6D, 12B, and 12D illustrate an alternative embodiment of the outer cover 610 according to another embodiment of the present disclosure wherein the outer cover includes a four-sided observation port or window 612. In other embodiments, the window may be of a different geometric shape suitable to frame an indicia symbol on the underlying reminder wheel.

As to the preferred mode of practicing this invention, after opening the container (such as a medication bottle) and conducting an act (such as taking a dose of medication), the user can replace the entire cap assembly atop the container and set the “next time to act” (i.e., the next time to take another dose of medication) by rotating the outer cover with respect to the reminder wheel. The “next time to act” index will not change if the user opens the container between the acts to be taken by removing the entire cap assembly. That is, the “next time to act” indicator is not automatically and inadvertently rotatingly advanced every time the container is merely opened, but only if the user intentionally rotates the outer wheel.

Various aspects of different embodiments of the present invention are expressed in paragraphs X1, X2, and X3 as follows:

X1. One aspect of the present invention pertains to a reminder cap comprising a reminder wheel including at least one indicia symbol, wherein the at least one indicia symbol correlates to a sequence of a medication dose; and an outer cover engaging the reminder wheel, the outer cover rotatable relative to the reminder wheel, the outer cover including a window; wherein the reminder wheel includes one of at least one jut and at least one recess, located co-radially to the at least one indicia symbol; wherein the outer cover includes the other of at least one jut and at least one recess, located co-radially to the window; wherein the at least one jut is configured to engage the at least one recess as a detent mechanism; and wherein the window is configured to frame the indicia symbol when the jut engages the recess.

X2. Another aspect of the present invention pertains to a method for providing a reminder comprising providing a bottle having a cap, the bottle for containing a dose of medication; attaching to the cap a reminder wheel, the reminder wheel rotatably engaged by an outer cover including a window; and rotating the outer cover until the window frames an indicia symbol on the reminder wheel corresponding to a next time to take the dose of medication.

X3. Yet another aspect of the present invention pertains to a method for providing a reminder comprising providing a bottle, the bottle for containing a dose of medication; providing a cap for the bottle, the cap including an integral reminder wheel, the reminder wheel rotatably engaged by an outer cover including a window; and rotating the outer cover until the window frames an indicia symbol on the reminder wheel corresponding to a next time to take the dose of medication.

Yet other embodiments pertain to any of the previous statements X1 and X2 which are combined with one or more of the following other aspects:

Wherein the reminder wheel is part of a bottle cap.

Wherein the at least one indicia symbol includes a plurality of indicia symbols correlating to a repetitive sequence of medication doses.

Wherein the at least one indicia symbol is color coded.

Wherein the outer cover includes knurls or teeth disposed about an outer peripheral edge of the outer cover.

Wherein the outer cover partially covers the reminder wheel.

Wherein the the reminder wheel includes a plurality of radially spaced recesses, and wherein the reminder wheel includes a plurality of radially spaced indicia symbols, each of the plurality of indicia symbols located co-radially to one of the plurality of recesses.

Wherein the outer cover is restrained from rotating in a counter-clockwise direction.

Wherein at least one of the at least one jut and the at least one recess is shaped to restrain the outer cover from rotating in a counter-clockwise direction.

Wherein the reminder cap includes a recess located co-radially to the indicia symbol.

Wherein the outer cover includes a jut located co-radially to the window, the jut configured to engage the recess as part of a detent mechanism.

Wherein the window is configured to frame the indicia symbol when the jut engages the recess.

Wherein the reminder cap includes a jut located co-radially to the indicia symbol.

Wherein the outer cover includes a recess located co-radially to the window, the jut configured to engage the recess as part of a detent mechanism.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

1. A reminder cap comprising:
a reminder wheel including at least one indicia symbol, wherein the at least one indicia symbol correlates to a sequence of a medication dose; and
an outer cover engaging the reminder wheel, the outer cover rotatable relative to the reminder wheel, the outer cover including a window;
wherein the reminder wheel includes one of at least one jut and at least one recess, located co-radially to the at least one indicia symbol;
wherein the outer cover includes the other of at least one jut and at least one recess, located co-radially to the window;
wherein the at least one jut is configured to engage the at least one recess as a detent mechanism; and
wherein the window is configured to frame the indicia symbol when the jut engages the recess.

2. The cap of claim 1 wherein the reminder wheel is part of a bottle cap.

3. The cap of claim 1 wherein the at least one indicia symbol includes a plurality of indicia symbols correlating to a repetitive sequence of medication doses.

4. The cap of claim 1 wherein the at least one indicia symbol is color coded.

5. The cap of claim 1 wherein the outer cover includes knurls or teeth disposed about an outer peripheral edge of the outer cover.

6. The cap of claim 1 wherein the outer cover partially covers the reminder wheel.

7. The cap of claim 1 wherein the reminder wheel includes a plurality of radially spaced recesses, and wherein the reminder wheel includes a plurality of radially spaced indicia symbols, each of the plurality of indicia symbols located co-radially to one of the plurality of recesses.

8. The cap of claim 1 wherein the outer cover is restrained from rotating in a counter-clockwise direction with respect to the reminder wheel.

9. The cap of claim 8 wherein at least one of the at least one jut and the at least one recess is shaped to restrain the outer cover from rotating in a counter-clockwise direction with respect to the reminder wheel.

10. A method for providing a reminder comprising:
providing a bottle having a cap, the bottle for containing a dose of medication;
attaching to the cap a reminder wheel, the reminder wheel rotatably engaged by an outer cover including a window; and
rotating the outer cover with respect to the reminder wheel until the window frames an indicia symbol on the reminder wheel corresponding to a next time to take the dose of medication.

11. The method of claim 10 wherein the reminder cap includes a recess located co-radially to the indicia symbol;
wherein the outer cover includes a jut located co-radially to the window, the jut configured to engage the recess as part of a detent mechanism; and
wherein the window is configured to frame the indicia symbol when the jut engages the recess.

12. The method of claim 10 wherein the reminder cap includes a jut located co-radially to the indicia symbol;
wherein the outer cover includes a recess located co-radially to the window, the jut configured to engage the recess as part of a detent mechanism; and
wherein the window is configured to frame the indicia symbol when the jut engages the recess.

13. A method for providing a reminder comprising:
providing a bottle, the bottle for containing a dose of medication;
providing a cap for the bottle, the cap including an integral reminder wheel, the reminder wheel rotatably engaged by an outer cover including a window; and
rotating the outer cover with respect to the reminder wheel until the window frames an indicia symbol on the reminder wheel corresponding to a next time to take the dose of medication.

14. The method of claim 13 wherein the reminder cap includes a recess located co-radially to the indicia symbol;
wherein the outer cover includes a jut located co-radially to the window, the jut configured to engage the recess as part of a detent mechanism; and
wherein the window is configured to frame the indicia symbol when the jut engages the recess.

15. The method of claim 13 wherein the reminder cap includes a jut located co-radially to the indicia symbol;
wherein the outer cover includes a recess located co-radially to the window, the jut configured to engage the recess as part of a detent mechanism; and
wherein the window is configured to frame the indicia symbol when the jut engages the recess.

16. The cap of claim 2 wherein the outer cover is restrained from rotating in a counter-clockwise direction with respect to the reminder wheel, and wherein the bottle cap is configured to rotate counter-clockwise with respect to a bottle to remove the bottle cap from the bottle.

17. The method of claim 2 wherein rotation of the outer cover with respect to the reminder wheel is independent of rotation of the bottle cap with respect to a bottle.

18. The method of claim 10 wherein rotating the outer cover with respect to the reminder wheel does not rotate the reminder wheel with respect to the bottle.

19. The method of claim 13 wherein the outer cover is configured to rotate clockwise with respect to the reminder wheel until the window frames an indicia symbol on the reminder wheel corresponding to a next time to take the dose of medication; and wherein the cap is configured to rotate counter-clockwise with respect to the bottle to remove the cap from the bottle.
